(19) United States
(12) Patent Application Publication
(10) Pub. No.: US 2006/0105794 A1
(43) Pub. Date: May 18, 2006

(54) Push to view system for telephone communications

(75) Inventors: Michael P. Carlson, Austin, TX (US); Herman Rodriguez, Austin, TX (US)

Correspondence Address: Greg Goshorn, P.C., 2110 W. Slaughter lane, SUITE 115-119, AUSTIN, TX, 78748, US

(73) Assignee: INTERNATIONAL BUSINESS MACHINES CORPORATION, ARMONK, NY (US)

(21) Appl. No.: 10/988,457

(22) Filed: Nov. 12, 2004

(51) Int. Cl. H04Q 7/20

(52) U.S. Cl. 455/518; 455/509; 455/414.1

(57) ABSTRACT

Provided is a system for providing a “push-to-view” (P2V) capability in conjunction with telecommunication devices. When a key, button or switch on a telecommunication device is pressed or switched, a camera at a remote site is activated. An image is then transmitted from the remote camera and displayed on the communication device. A P2V button enables the function. A separate button enables a user to toggle the P2V button back and forth between the P2V functionality and a push-to-talk functionality. A remote site can either be predefined or selected from a number of possibilities displayed in an address book. A remote device can be configured to automatically accept the view request or may determine whether or not to accept the request based upon the identity of the requesting party and/or other factors. An audio or visual indicator is activated during the viewing action unless a stealth mode is selected.

### TECHNICAL FIELD

The present invention relates generally to the transmission of video over a telephone line and, more specifically, to a system for viewing a remote site in a near-real-time manner.

### BACKGROUND OF THE INVENTION

Communication systems have several different possible modes of operation. Some media are half-duplex, i.e. communication occurs only in one direction at a time. An example of half-duplex is a typical walkie-talkie system. Although two parties in a walkie-talkie system can talk to each other, only one person may talk at a particular time. Most communication systems are full duplex, i.e. communication can travel concurrently in two directions. The plain old telephone system (POTS) is an example of a full duplex system.

In recent years, competition in the telephone industry has inspired many service providers to offer new, previously unavailable features in a bid to attract and retain customers. One surprising development is the re-introduction of half-duplex communication features, since this a method of communication was practically eliminated from POTS decades ago. One such feature is “push-to-talk,” in which a user is able to send voice data to a remote user in a near-real-time fashion with a simple push of a button on a telephone. Like a walkie-talkie, push-to-talk information is transmitted only while the corresponding button is pushed.

Push-to-talk has proved useful and become popular and widespread in the service and repair industries because it enables a supervisor or central dispatcher to instantly communicate important information to service and/or repair personnel in the field. Telephone service providers also appreciate the service because this feature only requires the establishment of a single transmit channel. Such half-duplex communication is a cost efficient feature for network operators to setup, maintain and operate.

Another similar feature is “push-to-send” video, in which a user transmits a video image in a manner similar to the push-to-talk feature. Again, network operators support the service because of the ease and low cost of establishing such a connection.

### SUMMARY OF THE INVENTION

Provided is a system for providing a “push-to-view” (P2V) capability in conjunction with telecommunication devices such as, but not limited to, a telephone or mobile wireless phone. P2V functionality enables a user to press a P2V key, button or switch on an existing telecommunication device and thereby activate a camera at a remote site. An image is then captured and transmitted from the remote camera and displayed on the communication device. By employing the disclosed technology, a user can sequentially view one or more remote sites in a near real-time manner.

The claimed subject matter is useful in settings such as child-care centers, convalescent and senior health care units and in any environment in which security or vigilance is an issue. Typically, the remote viewing last as long as the P2V key, button or switch is activated. In the alternative, the key button or switch may provide a one-shot capture of a video image from a selected remote site or the remote viewing may remain activated until a second push of the P2V key button or switch or another button.

On an exemplary P2V device, a P2V button enables the function. A separate button enables a user to toggle the P2V button back and forth between the P2V functionality and a push-to-talk (P2T) functionality or a push-to-send functionality. When the P2V button is pressed, a signal indicating the view request and the identity of the requesting party is transmitted a specially outfitted device at a selected remote site. The remote site and corresponding device can either be predefined or selected from a number of possibilities displayed in an address book. A number of possible viewing site entries form a viewing group.

The remote device can be configured to automatically accept the request for viewing or may determine whether or not to accept the request based upon the identity of the requesting party and/or other factors. If the request is accepted, a half-duplex, or single channel, connection is established between the remote device and the users P2V device. An audio or visual indicator on the remote device is provided for signaling that a remote viewing is in progress. Information transmitted with the viewing request may include instructions for viewing in a stealth mode, i.e. the audio or visual indicator is not activated during the viewing action.

The viewing ends when the P2V button is released or when action is taken at the remote site to terminate the viewing session. In the alternative, a press of the P2V button is treated as a request for snapshot. In that case, if the request is granted, a channel is established, the snapshot is transmitted to the requesting party and the connection is automatically terminated. In another embodiment, a press of the P2V button activates the P2V session and a second push of the P2V button or another designated button ends the session.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of a telecommunications system that supports the disclosed push-to-view (P2V) technology.

FIG. 2 is a block diagram of the mobile wireless phone of FIG. 1 in more detail.

FIG. 3 is a block diagram of the remote site camera of FIG. 1 in more detail.

FIG. 4 is a flowchart of the establishment, or setup, of a P2V session.

FIG. 5 is a flowchart of a P2V session transmission process.

FIG. 6 is a flowchart of a P2V session termination process.

### DETAILED DESCRIPTION OF THE FIGURES

Although described with particular reference to a visual sensing capability implemented over a standard telephone connection, the claimed subject matter can be implemented in any telecommunication system in which remote viewing or sensing is desirable. Those with skill in the telecommunications and computing arts will recognize that the disclosed embodiments have relevance to a wide variety of telecommunication environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

There are at least two entities involved with an implementation of the claimed subject matter: a receiving party, also referred to throughout this description as the “initiating,” “local, or “receiving” side, and a transmitting party, also referred to as the “remote” side. Any particular device may be configured to function only as one side of the technology or, typically at different times, as both transmitting and receiving sides.

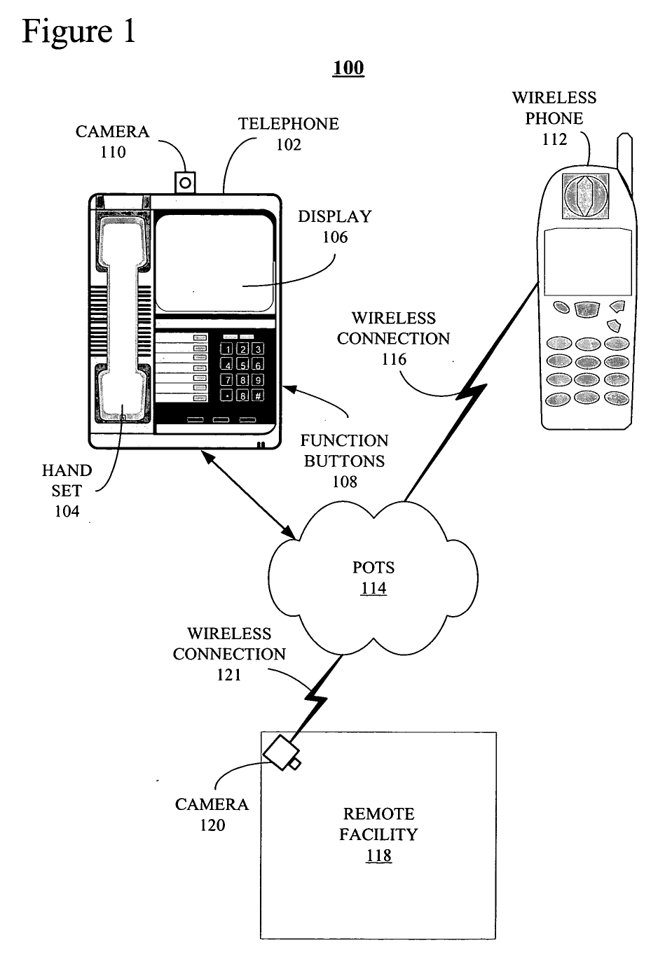

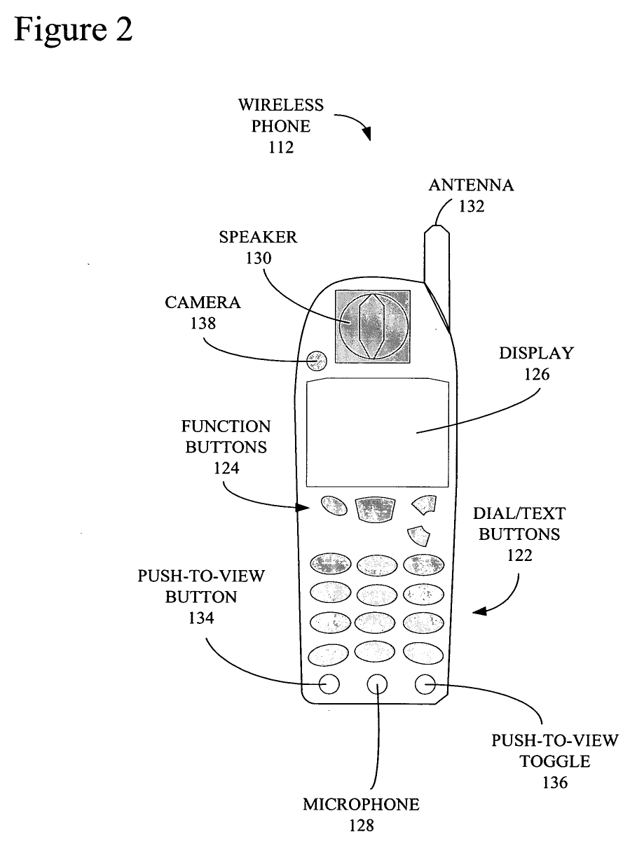

FIG. 1 is a block diagram of an exemplary telecommunications system 100 that supports the disclosed push-to-view (P2V) technology. System 100 includes a telephone 102 and a mobile wireless phone 112, both of which are connected to a plain old telephone service (POTS) 114. Wireless phone 112, which is coupled to POTS 114 via a wireless connection 116, is described in more detail below in conjunction with FIG. 2. Of course, many other types of devices can be employed to implement the claimed subject matter. For example, many communication functions typically associated with telephones can now be performed via a personal computer (not shown). Further, POTS is used only as an example, the disclosed technology may be implemented via direct connection, the Internet, a digital packet network or any other suitable communication medium.

Telephone 102 includes a handset 104, a display 106, function buttons 108 and a camera 110. Handset 104 includes a microphone (not shown) and a speaker (not shown) and should be familiar to anyone who has used a telephone. Display 106 displays information such as a time, date, a dialed telephone number and the telephone number of a calling party. In addition, display 104 can show images captured according to the claimed subject matter.

Function buttons 108 include buttons for entering alphanumeric digits, which should be familiar to those who have used a telephone. In addition, function buttons include a button (not shown) that activates the disclosed P2V technology and a toggle button (not shown) that switches the P2V activation button between a P2V activation button and a push-to-talk (P2T) activation button. Buttons with a similar functionality as the P2V activation and toggle buttons on wireless phone 112 are described in more detail below in conjunction with FIG. 2. Camera 110 captures video images for transmission, either in conjunction with a telephone call or in conjunction with a P2V request from another P2V device.

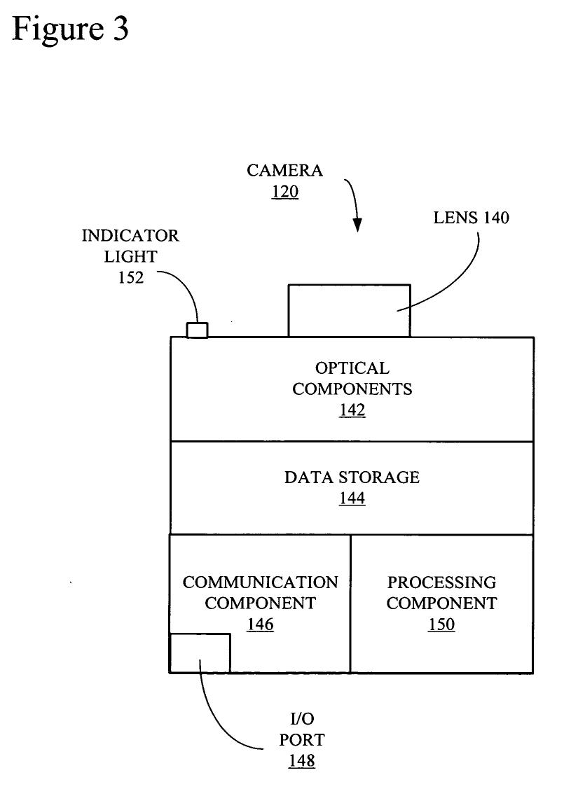

System 100 also includes an exemplary remote facility 118 and a camera 120 mounted at remote facility 118 for monitoring purposes. Camera 120 is communicatively coupled to POTS 114 via a wireless connection 121. For the purposes of the following examples, facility 118 is used as an example of a transmitting side of the claimed subject matter and is “remote” in the sense that camera 120 is not located on the initiating device used in the examples. Camera 120, which is engineered to implement the claimed subject matter, is described in more detail below in conjunction with FIG. 3. Further, facility 118 is used only as an example; other types of facilities include, but are not limited to, hospitals, day-care centers, elder-care centers, warehouses, and so on.

FIG. 2 is a block diagram of wireless phone 112 of FIG. 1 in more detail. Wireless phone 112 includes dial/text buttons 122, which should be familiar to anyone who has used a wireless phone as the buttons employed to enter telephone numbers and text messages, as well as serving other data entry functions. A set of function buttons 124 includes buttons for such functionality as a “clear” button, an “Enter” button, and up and down, or “scrolling,” buttons, none of which are individually labeled. Again, one with experience using a wireless phone should recognize function buttons 124.

A display 126 provides a user with information such as, but not limited to, date, time, called and received telephone numbers, mode, status and images captured according to the claimed subject matter. A microphone 128 and a speaker 130 provide the means to speak and listen to, respectively, conversations and other signals. An antenna 132 provides the means to send and receive signals over wireless connection 116 (FIG. 1).

A P2V button 134 enables the user of wireless phone 112 to activate the claimed P2V features. P2V button 134 either activates a predefined connection, for example to camera 120 (FIG. 1) at secure facility 118 (FIG. 1) or causes a menu of available P2V location choices to be displayed on display 126. If a menu is displayed, then the user selects a particular location for remote viewing by pressing appropriate function buttons 124. A P2V toggle button 136 enable the user to select either a P2V function or a P2T function by causing wireless phone 112 to switch back and forth between the two functionalities. In the alternative, toggle button 136 causes wireless phone 112 to toggle between P2V functionality and push-to-send (P2S) functionality. Toggle button 136 may toggle wireless phone between P2V, P2T and P2S functionality. Finally, a camera 138 is able to transmit an image form wireless phone 112 to some other communication device, including a device configured with P2V technology.

FIG. 3 is a block diagram of camera 120 mounted at remote site 118 of FIG. 1 in more detail. Camera 120 includes a lens 140 and optical components 142 for capturing an image and converting the captured image into an electronic format. A memory, or data storage, 144 holds both stored, captured images and any logic necessary for implementing the claimed subject matter. A communication component 146 handles, via an input/output (I/O) port 148, the interaction between camera 120 and the outside world via wireless connection 112 (FIG. 1). Those with skill in the communication and telephony arts should realize there are many suitable forms of communication for camera 120 to communicate with devices such as telephone 102 and wireless phone 112. The connection can be, but is not limited to, a direct connection to POTS 114 or a wireless connection like wireless connection 121.

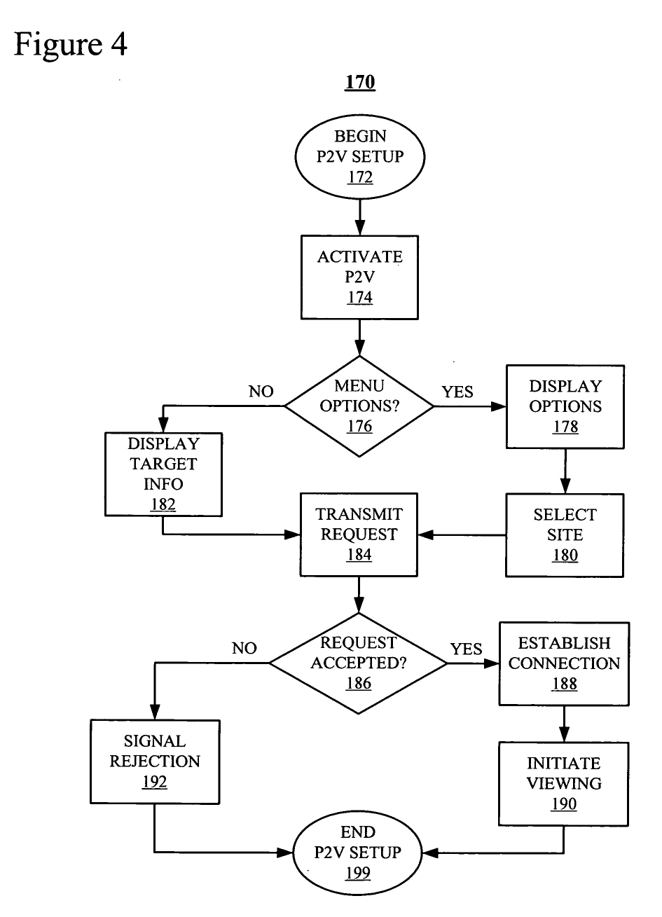

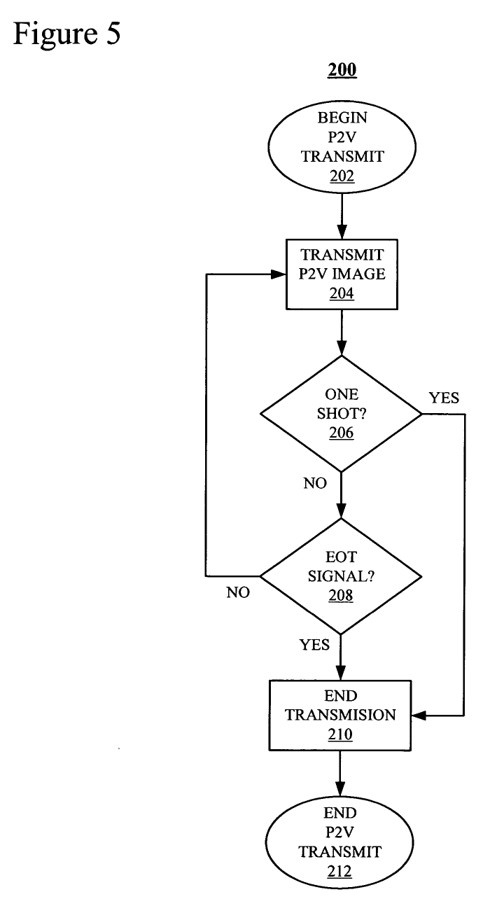

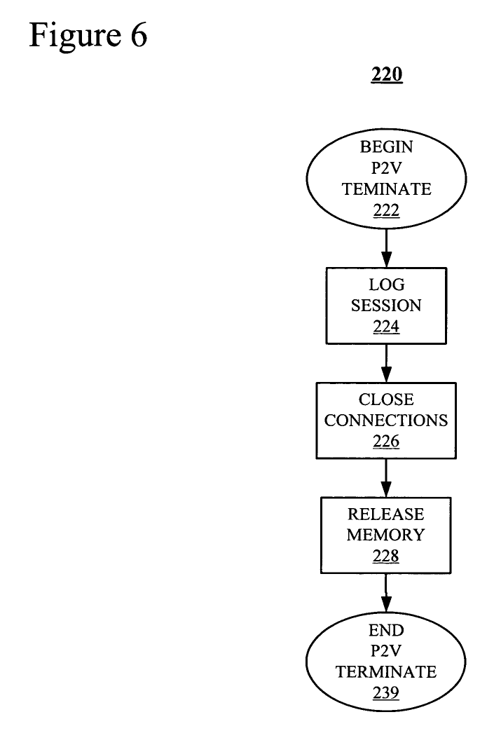

A processing component 150 executes logic stored in data storage 144 to implement the portion of the claimed subject matter that executes at the remote site side of the P2V technology. Exemplary processes that implement the claimed subject matter include a P2V setup process 170 described below in conjunction with FIG. 4, a P2V transmit process 190, described below in conjunction with FIG. 5, and a P2V termination process 220 described below in conjunction with FIG. 6.

Finally, an indicator light 152, mounted on camera 120, lights up when camera 120 is transmitting in a P2V session. In the alternative, camera 120 may include a stealth mode in which, due to a preset configuration factor or a specific request for a device requesting a P2V transmission, indicator light 152 does not light up during a P2V session.

FIG. 4 is a flowchart of an establishment, or setup, process 170 of a P2V session. Setup process 170 starts in a “Begin P2V Setup” block 172 and control proceeds immediately to an “Activate P2V” block 174. Process 170 is executed when a user pushes P2V button 134 (FIG. 2) of wireless phone 112 (FIGS. 1 and 2). Throughout the remaining description, wireless phone 112 is used as an example of an initiating device and camera 120 (FIGS. 1 and 2) at remote facility 118 (FIGS. 1 and 2) is used as an example of a remote device. During block 174, process 170 searches memory (not shown) to identify a remote device as the target of the P2V request. There may be a single dedicated target or a list of targets saved in an address book (not shown) of wireless phone 112.

Process 170 then proceeds to a “Menu Options?” block 176 in which process 170 determines whether or not there are multiple potential targets. If there are multiple target options, then control proceeds to a “Display Options” block 178 during which the user is presented with a list of potential target sites in display 126 (FIG. 2). Process 170 then proceeds to a “Select Site” block 180 during which the user selects one of the potential sites as the target of the P2V request. On a device such as wireless phone 112, a user typically selects a particular target by using function buttons 124, a process which should be familiar to those with experience with wireless phones. If the P2V request is initiated from a device such as personal digital assistant (PDA), then a stylus device is typically pressed against a display to select a menu option.

If, in block 176, process 170 determines there is only one potential target, then control proceeds to a “Display Target Info” block 182 during which information identifying the potential target is presented in display 126 while the connection is initiated. Once a particular target, in this example camera 120, has been specified, either because the target is the only potential target via block 182 or because the target was selected during block 180, control proceeds to a “Transmit Request” block 184. During block 184, a signal is transmitted from wireless phone 112 to camera 120 requesting that a P2V connection be established. The signal includes data that identifies the party or device that initiated the signal. Of course, the request must go through a service provider that supports P2V service, in this example, POTS 114 (FIG. 1).

Process 170 then proceeds to a “Request Accepted?” block 186 during which the target device, in this example camera 120, determines whether or not to accept the request transmitted in block 184. Some target devices may be configured to automatically accept a request for a P2V session. However, typically camera 120 accepts or declines the request based upon whether or not the party that transmitted the signal is authorized to make such a request. Other conditions may be placed upon the acceptance of the request such as, but not limited to, the existence of another concurrent request or the particular time of day. For example, a day care facility may only accept a P2V request from a parent during the time the parent's child is in attendance at the day care facility.

If the connection request is accepted, then control proceeds to an “Establish Connection” block 188 during which the target device 120 signals POTS 114 that a connection is accepted and POTS 114 establishes a half duplex connection from camera 120 to wireless phone 112. Control then proceeds to an “Initiate Viewing” block 190 during which process 170 initiates a P2V Transmit process 200, which is described in detail below in conjunction with FIG. 5.

If during block 186, process 170 determines that camera 120 has rejected the P2V request, then control proceeds to a “Signal Rejection” block 192 during which wireless phone 112 is notified of the rejection. From both block 190 and block 192, process 170 proceeds to an “End P2V Setup” block 199 in which process 170 is complete.

FIG. 5 is a flowchart of P2V transmit process 200. Process 200 starts in a “Begin P2V Transmit” block 202 and proceeds immediately to a “Transmit P2V Image” block 204. During block 204, process 200 captures an image from camera 120 (FIGS. 1 and 3), stores the image in data storage 144 (FIG. 3), processes the image with processing component 150 (FIG. 3) and transmits the image with communication component 146 (FIG. 3). The transmitted image is received by wireless phone 112 (FIGS. 1 and 2) and can be viewed by the user on display 126 (FIG. 2).

Process 200 then proceeds to a “One Shot?” block 206 during which process 200 determines whether or not the current P2V session is configured as a “one-shot” session, i.e. only one image is captured before the connection is automatically terminated. This configuration information can be included either as part of camera 120 configuration information, which is stored in data storage 144, included in the original P2V view request sent by wireless phone 112 or some combination of the two. If the current P2V session is configured as a one-shot session, then process 200 proceeds to an “End Transmission” block 210, which is described in more detail below in conjunction with FIG. 6.

If in block 206 process 200 determines that the current P2V session is not a one-shot session, then control proceeds to an “EOT Signal” block 208 during which process 200 determines whether or not an end-of-transmission (EOT) signal has been received from wireless phone 112. An EOT signal is sent from wireless phone 112 when the user who initiated P2V process 200 releases P2V button 134 (FIG. 2). In the alternative, a P2V transmission can continue until the user explicitly sends an EOT signal by, for example, pressing an appropriate function button 124 (FIG. 2) or pressing P2V button 134 a second time.

If an EOT signal has not been received, process 200 returns to Transmit P2V Image block 204 and control proceeds as described above. If an EOT signal is received, then process 200 proceeds to End Transmission block 210. Finally, from block 210, process 200 proceeds to an “End P2V Transmit” block 212 in which process 200 is compete.

FIG. 6 is a flowchart of a P2V Terminate process 220, which corresponds to End Transmission block 210 of FIG. 5. Process 220 starts in a “Begin P2V Terminate” block 222 and proceeds immediately to a “Log Session” block 224. During block 224, process 220 records in data storage 144 (FIG. 3) information relating to the P2V session that is being terminated. Information includes, but is not limited to, date and time information and the identification of the party that requested the viewing. In addition, wireless phone 112 may log information concerning the current P2V session. Process 220 then proceeds to a “Close Connections” block 226 during which the half duplex connection opened during Establish Connection block 188 of process 170 (FIG. 4) is closed.

Process 220 then proceeds to a “Release Memory” block 228 during which any memory of processing component 150 (FIG. 3) used to execute process 220 (FIG. 5) is released. Finally, control proceeds to an “End P2V Terminate” block 239 in which process 220 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A system for providing push-to-view (P2V) functionality, comprising:
a wireless telephone;
a P2V button on the wireless telephone; and
a P2V functionality activated by pressing the P2V button, the P2V functionality comprising:
a half duplex connection from a camera at a remote connection to the wireless telephone; and
an image captured by the camera and transmitted to the wireless telephone via the half duplex connection.

2. The system of claim 1, further comprising a toggle functionality, wherein the toggle functionality switches the P2V button between activation of the P2V functionality and an activation of a push-to-talk (P2T) functionality.

3. The system of claim 1, further comprising a toggle functionality, wherein the toggle functionality switches the P2V button between activation of the P2V functionality and an activation of a push-to-send (P2S) video functionality.

4. The system of claim 1, further comprising a viewing group wherein the remote site is selected from a plurality of remote sites that define the viewing group.

5. The system of claim 1, wherein the remote connection is a telephone.

6. The system of claim 1, wherein the remote connection is configured to accept a request for the P2V functionality from a specific wireless device.

7. The system of claim 1, wherein the remote connection is configured to accept a request for the P2V functionality from any suitable configured wireless device.

8. A method for providing push-to-view (P2V) functionality, comprising:
configuring a wireless telephone with a P2V button; and
activating the P2V functionality by pressing the P2V button, the P2V functionality comprising:
establishing a half duplex connection from a camera at a remote connection to the wireless telephone;
capturing an image by the camera; and
transmitting the image to the wireless telephone via the half duplex connection.

9. The method of claim 8, further comprising providing a toggle functionality, wherein the toggle functionality comprises switching the P2V button between activation of the P2V functionality and an activation of a push-to-talk (P2T) functionality.

10. The method of claim 8, further comprising providing a toggle functionality, wherein the toggle functionality comprises switches the P2V button between activation of the P2V functionality and an activation of a push-to-send (P2S) video functionality.

11. The method of claim 8, further comprising:
defining a viewing group based upon a plurality of remote sites; and
selecting the remote site from the plurality of remote sites that define the viewing group.

12. The method of claim 8, wherein the remote connection is a telephone.

13. The method of claim 8, wherein the remote connection is configured to accept a request for the P2V functionality from a specific wireless device.

14. The method of claim 8, wherein the remote connection is configured to accept a request for the P2V functionality from any suitable configured wireless device.

15. A computer programming product for providing push-to-view (P2V) functionality, comprising:
a wireless telephone
a memory;
a P2V button on the wireless phone; and
logic, stored on the memory, for activating a P2V functionality by pressing the P2V button, the P2V functionality comprising:
logic, stored on the memory, for establishing a half duplex connection from a camera at a remote connection to the wireless telephone; and
logic, stored on the memory, for receiving, via the half duplex connection, an image captured by the camera.

16. The computer programming product of claim 15, further comprising logic, stored on the memory, for providing a toggle functionality, wherein the toggle functionality comprises switching the P2V button between activation of the P2V functionality and an activation of a push-to-talk (P2T) functionality.

17. The computer programming product of claim 15, further comprising:
logic, stored on the memory, for defining a viewing group based upon a plurality of remote sites; and
logic, stored on the memory, for selecting the remote site from the plurality of remote sites that define the viewing group.

18. The computer programming product of claim 15, wherein the remote connection is a telephone.

19. The computer programming product of claim 15, wherein the remote connection is configured to accept a request for the P2V functionality from a specific wireless device.

20. The computer programming product of claim 15, wherein the remote connection is configured to accept a request for the P2V functionality from any suitable configured wireless device.
